(19) United States
(12) Patent Application Publication
(10) Pub. No.: US 2026/0334517 A1
(43) Pub. Date: Oct. 29, 2026

(54) SAVORY PRODUCT COMPRISING STABLE POLYUNSATURATED FATTY ACID

(71) Applicant: SOCIÉTÉ DES PRODUITS NESTLÉ S.A., Vevey (CH)

(72) Inventors: Jwanro HUSSON, Lausanne 25 (CH); Lilian BARRO, La ville Aux Dames (FR); Tat Wei YAN, Singen (DE)

(21) Appl. No.: 19/107,448

(22) PCT Filed: Aug. 30, 2023
(86) PCT No.: PCT/EP2023/073745

§ 371 Date: Feb. 27, 2025

(30) Foreign Application Priority Data
Aug. 31, 2022 (EP) 22193236.1

(51) Int. Cl. A23L 23/10; A23L 29/00; A23L 29/212

(52) U.S. Cl. CPC A23L 23/10; A23L 29/04; A23L 29/212

(57) ABSTRACT

The invention relates to a method of making a savory product, said method comprising wet mixing a composition comprising (i) one or more of flax seed, hemp or chia; (ii) oil source; and (iii) protein source; blending the wet mix; heating the blended mix; and cooling to form a savory product with a total solid content of between 10 to 65 wt %.

### INTRODUCTION

Savory products like soup pastes and soup concentrates are popular worldwide as a convenient starting material which can be diluted to make soup. However, these types of products often have a poor texture and nutritional profile and therefore fail to meet consumer expectations. Products exist on the market which have been supplemented with healthy fats such as polyunsaturated fatty acids (PUFAs), but in order to keep a long shelf life they need to contain many additives such as antioxidants and emulsifiers. Although they help to limit or prevent oxidation and off flavors, they have a poor image with consumers.

There is a clear need for clean label soup pastes and soup concentrates with a good texture and improved nutritional profile, but do not suffer from unwanted oxidation and off flavors.

### SUMMARY OF THE INVENTION

The invention relates in general to a method of making a savory product, said method comprising blending a wet mix composition comprising one or more oilseeds, for example flax seed, hemp or chia.

The invention further relates to a method of making a savory product, said method comprising wet mixing a composition comprising (i) one or more of flax seed, hemp or chia; (ii) oil source; and (iii) protein source; and blending the wet mix.

The invention further relates to a method of making a savory product, said method comprising a) wet mixing a composition comprising (i) one or more of flax seed, hemp or chia; (ii) oil source; and (iii) protein source; b) blending the wet mix; and c) heating the blended mix.

The invention further relates to a method of making a savory product, said method comprising a) wet mixing a composition comprising (i) one or more of flax seed, hemp or chia; (ii) oil source; and (iii) protein source; b) blending the wet mix; c) heating the blended mix; and d) cooling to form a savory product with a total solid content of between 10 to 65 wt %.

In one embodiment, the savory product is a soup concentrate product, wherein in step b) the wet mix is blended with a dry mix of ingredients.

In one embodiment, said method comprises: (i) forming a wet mix of ingredients comprising one or more of flax seeds, hemp, or chia; oil source; and protein source; (ii) blending the wet mix with a dry mix of ingredients to form a blended mix; (iii) heating the blended mix; and (iv) cooling to form a savory product with a total solid content of between 10 to 65 wt %.

In one embodiment, mucilage has been substantially removed or entirely removed from the flax seed.

In one embodiment, the mucilage has been substantially removed by mixing the flax seeds in water, and applying heat to the mixture.

In one embodiment, the mucilage has been substantially removed by mixing the flax seeds in water, adjusting the pH to about 6, and applying heat to the mixture.

In one embodiment, the flax seeds are at least 50% dehulled.

In one embodiment, the flax seeds are whole flax seeds.

In one embodiment, the wet mix is formed by shearing the one or more of flax seeds, hemp, or chia in water with crystals with the protein source, wherein the protein source is a protein powder, and wherein the crystals are salt and/or sugars.

In one embodiment, the wet mix in step (i) is pre-blended, before blending with the dry mix of ingredients.

In one embodiment, the blended mix is heated to at least 85 °C in step (iii).

In one embodiment, the blended mix is cooled down to about 40 °C after heating.

In one embodiment, starch and optionally water is added during or after cooling in step d).

The invention further relates to a savory product, preferably a soup concentrate product, said product comprising between 5 to 20 wt % flax seed, hemp, or chia.

In one embodiment, the flax seeds are at least 50% dehulled.

In one embodiment, the flax seeds are substantially free of mucilage.

In one embodiment, the wet mix comprises 20-35 wt % water, 10-20 wt % fiber, 5-15 wt % sunflower oil, and 8-20 wt % flax seed or hemp or chia.

The invention further relates to a savory product made by a method according to the invention.

The invention further relates to a liquid soup product, made by mixing the soup concentrate product according to the invention in water.

The invention further relates to a savory product or liquid soup product as described herein, wherein said products are substantially devoid of emulsifiers and/or antioxidants.

The invention further relates to the use of flax seed which is at least 50% dehulled and/or substantially free of mucilage to make a savory product, for example a soup concentrate product or a soup paste or a liquid soup product.

### DETAILED DESCRIPTION OF THE INVENTION

The method of making a savory product, for example a soup concentrate, may comprise the following steps: wet mixing a composition comprising (i) one or more of flax seed, hemp, and chia; (ii) oil source; and (iii) protein source.

The flax seed may be dehulled, for example 50 to 70% dehulled, or at least 70% dehulled. The wet mixed composition may comprise between 5 to 20 wt % flax seed, or between 5 to 15 wt % flax seed, or about 9.6 wt % dehulled flax seed, or about 9.6 wt % flax seed without mucilage, or about 8.2 wt % whole flax seed.

The wet mixed composition may comprise between 5 to 20 wt % chia, or between 7 to 12 wt % chia, or between 9 to 10 wt % chia.

The wet mixed composition may comprise between 10 to 30 wt % hemp, or between 12 to 25 wt % hemp, or between 17 to 20 wt % hemp.

Other ingredients are typically added, for example, one or more of sunflower oil, soy protein, onion powder, and mushroom granular. Other flavors may be pre-blended and also added.

The wet mix composition can be further mixed. It can then be sheared, for example with crystals, for example salts and/sugars, and with a powder, for example soy protein isolate or pea protein isolate or a dairy based powder, for example whey powder or milk powder. Shearing may be done, for example, in a Thermomix.

Other ingredients, for example dry ingredients, can be added separately. These ingredients mainly comprise spices and/or herbs. Alternatively, all the ingredients can be blended together provided that the solid content is not too high.

For example, if the solid content is 60% or less, or 50% or less, or 40% or less, or 30% or less, or 20% or less. The wet and dry mixes can then be combined and blended, for example using a Thermomix, and then pasteurized, for example, at 85 °C or higher. The mixture is then cooled, preferably to 40 °C or less. A Blast Chiller can be used, or it can be cooled at room temperature and/or by using ice.

Starch and water can be added and mixed, for example in a Thermomix. The starch can be potato starch, for example potato native starch. The starch is preferably added after cooling to get lower viscosity due to the starch being ungelatinized. The starch may have been heat treated. The starch can be corn starch, for example waxy corn starch.

The mixture can then be poured into a receptacle, for example a pouch. It can then be stored at room temperature. To make soup, the paste can be diluted, for example at ratio 1:4, with water, preferably hot water and stirred until dissolved. The wet mix can have the amounts of ingredients as shown in Table 1.

TABLE 1

| | Preferred | Preferred |
|---|---|---|
| | range | amount |
| Ingredient | (wt %) | (wt %) |
| Water | 20-35 | 27 |
| Fiber | 10-20 | 15 |
| Sunflower oil | 5-15 | 11 |
| Flax seed or hemp or chia | 8-20 | 10 |
| Other ingredients | To 100 | To 100 |
| (including spices) | | |

The savory product is preferably made according to the above method. The savory product preferably has a solids content between 10 to 65 wt %, or between 20 to 55 wt %, or between 30 to 45 wt %.

The savory product is preferably a paste or an emulsion. It may have a viscosity of between 13,000 mPa to 37,000 mPa at 20 °C. The omega-3 content of the savory product is typically between 0.5 to 5 wt %, or between 1 to 3 wt %, or about 1.5 wt %.

A savory product is a salty and/or spicy product. The savory product can be a soup concentrate or a sauce, preferably a soup concentrate. A concentrate means that the product is a paste.

Typically, the concentrate needs to be diluted with water by the consumer before cooking. Typically, the viscosity of a soup concentrate product at 20 °C is between 10000 to 100000 log mPa·s, or between 10000 to 80000 log mPa·s, or between 10000 to 60000 log mPa·s, or about 10000 mPa·s, or about 40000 mPa·s, or about 60000 mPa·s.

Typically, the viscosity of a soup concentrate product after reconstitution at 40 °C is between 50 to 350 log mPa·s, or between 60 to 325 log mPa·s, or between 70 to 300 log mPa·s, or about 70 mPa·s, or about 105 mPa·s, or at least about 290 mPa·s.

Typically, the viscosity of a soup concentrate product after reconstitution at 80 °C is between 10 to 220 log mPa·s, or between 20 to 210 log mPa·s, or between 30 to 200 log mPa·s, or about 30 mPa·s, or about 60 mPa·s, or about 200 mPa·s.

Typically, the product is substantially free of emulsifiers, for example artificial emulsifiers. Typically, the product is substantially free of antioxidants. Typically, the product is substantially free of hydrocolloids. Typically, the product is substantially free of modified starches. Typically, the product is substantially free of additives.

The savory product of the invention can be, for example, a soup concentrate product, soup paste, liquid soup product, or a sauce.

Typically, the savory product has a shelf-life of greater than six months when stored under ambient conditions, preferably between six months to twelve months.

Typically, the savory product has a shelf-life of greater than twelve months when stored under ambient conditions.

The definition of certain terminology used within the present application is provided below.

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 45 to 55 should be construed as supporting a range of from 46 to 54, from 48 to 52, from 49 to 51, from 49.5 to 50.5, and so forth.

As used herein, “substantially devoid” means being present in an amount less than 0.1 wt %, more preferably 0.05 wt %, more preferably being completely absent.

The term “vegetarian” refers to an edible composition which is entirely devoid of meat or fish products. The term “vegan” refers to an edible composition which is entirely devoid of animal products, or animal derived products. Non-limiting examples of animal products include meat, fish, eggs, milk, and honey.

Unless noted otherwise, all percentages in the specification refer to weight percent, where applicable.

When a composition of product or ingredient is described herein in terms of wt % (weight percent), this means wt % of the total recipe of the related product or ingredient, unless indicated otherwise. For example, ingredient B comprises xwt % of component b means that ingredient B comprises x % of component b by weight of ingredient B. Likewise, product C comprises ywt % of ingredient B means that product C comprises y % of ingredient B by weight of product C.

As used herein, the term “plant protein concentrate” refers to a plant composition comprising a plant protein content from 50% to 79.9%.

As used herein, the term “plant protein isolate” refers to a plant composition comprising a plant protein content from 80.0% to 99.0%.

By “shelf-stable”, it is understood a product which has a shelf-life of several months when stored under ambient conditions. This also generally applies when it is stored under chilled conditions. The term “ambient conditions” refers to temperatures ranging from 15 °C to 25 °C, preferably from 20 °C to 22 °C. Especially, a shelf-stable product has a shelf-life of at least 3 months, preferably of at least 6 months, more preferably at least 12 months, when stored under ambient conditions. These storage temperatures relate to the storage of the product before being commercially obtained by an end consumer. Generally, the end consumer is advised to store the product under the same ambient conditions until consumption, for example in a shelf at room temperature.

Unless defined otherwise, all technical and scientific terms have and should be given the same meaning as commonly understood by one of ordinary skill in the art to which this invention belongs.

### EXAMPLES

By way of example and not limitation, the following examples are illustrative of various embodiments of the present invention.

### Example 1

Recipe without Flax Seeds

A reference soup concentrate recipe was prepared as follows: the first step was the mixing of wet components (sunflower oil, soy protein, onion powder, mushroom granular and other flavor components) as a pre-blend wet base component which was then mixed and sheared with crystals and milk powder at speed 8 for 30 seconds using Thermomix and then speed 3 for 3 minutes to prevent lumps. Separately, the dry components comprising mainly of spices were mixed in a bowl to prevent lumps. Both wet and dry mixes were then combined and preblended at speed 3 for 3 minutes using a Thermomix and then pasteurized for 5 minutes at 85 °C, speed 3 with Thermomix. The mixture was then cooled down to 40 °C either by using a Blast Chiller, or at room temperature. The paste was then put in an aluminum bowl and then on ice for 5 minutes maximum. Starch and water were added to the slurry in a Thermomix at speed 4 for 1 minute and then poured into a pouch and stored at room temperature. To make the soup, the paste was dilute 1:4 with hot water and stirred until the paste dissolved.

### Example 2

Recipe with 70% Dehulled Flax Seeds

A soup concentrate recipe was prepared as follows: the first step was the mixing of wet components (sunflower oil, soy protein, onion powder, and other flavor components) as a pre-blend wet base component which was then mixed and sheared with crystals and milk powder at speed 8 for 30 seconds using Thermomix then speed 3, for 3 minutes to prevent lumps. The flax seed was added to around 9.62% of the wet components total weight. The advantage of using dehulled flax seeds is that the mucilage is partially removed. This helps to keep the viscosity of the concentrate close to the reference. Separately, the dry components comprising mainly of spices were mixed in a bowl to prevent lumps. Both wet and dry mixes were then combined and preblended at speed 3 for 3 minutes using a Thermomix and then pasteurized for 5 minutes at 85 °C, speed 3 with Thermomix. The mixture was then cooled down to 40 °C either by using a Blast Chiller, or at room temperature. The paste was then put in an aluminum bowl and then on ice for 5 minutes maximum. Starch and water were added to the slurry using a Thermomix, at speed 4 for 1 minute and then poured into a pouch and stored at room temperature. To make the soup, the paste was dilute 1:4 with hot water and stirred until the paste dissolved. The product stability at room temperature after 6 months and 12 months was measured (Table 2).

TABLE 2

| | Samples at room | | T |
|---|---|---|---|
| | temperature | T0 | (12 months) |
| Smell | Sample without | No fishy smell | No fishy |
| (sniffing) | flax seeds | | smell |
| | Sample with | No fishy smell | No fishy |
| | flax seeds | | smell |
| Taste & | Sample without | Mushroom taste | No change in |
| color | flax seeds | and brownish | taste & color |
| | | color | |
| | Sample with | Mushroom taste | No change in |
| | flax seeds | and brownish | taste & color |
| | | color | |

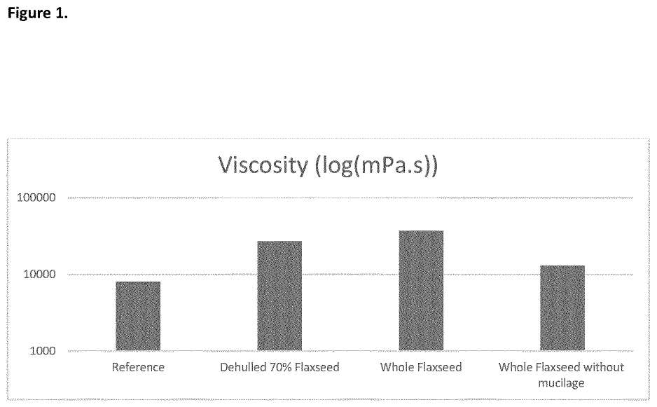

The soup concentrate viscosity at 20 °C was measured (FIG. 1). The recipe with flaxseeds without mucilage and 100% starch had the closest viscosity to the reference.

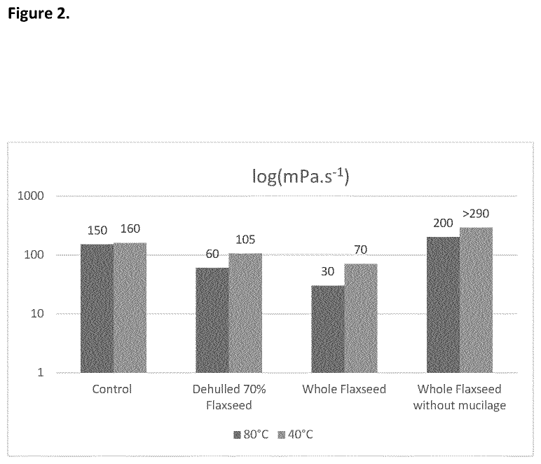

The soup viscosity after reconstitution in hot water at ratio 1:4 at 80 °C (FIG. 2, left hand columns) and 40 °C (FIG. 2, right hand columns) was measured.

### Example 3

Recipe with Whole Flax Seeds

The soup concentrate recipe was prepared as follows: the first step was the mixing of wet components (sunflower oil, soy protein, onion powder, and other flavor components) as a pre-blend wet base component which was then mixed and sheared with crystals and milk powder at speed 8 for 30 seconds in a Thermomix then speed 3, for 3 minutes to prevent lumps. The flax seed was added during this process to around 8.29% of the wet components total weight. Separately, the dry components comprising mainly of spices were mixed in a bowl to prevent lumps. Both wet and dry mixes were then combined and preblended at speed 3 for 3 minutes using a Thermomix and then pasteurized for 5 minutes at 85 °C, speed 3 with a Thermomix. The mixture was then cooled down to 40 °C either by using a Blast Chiller, or at room temperature, whereby the paste was put in an aluminum bowl and then using ice for 5 minutes maximum. Starch and water were added to the slurry using a Thermomix, at speed 4 for 1 minute and then poured into a pouch and stored at room temperature. To make the soup, the paste was dilute 1:4 with hot water and stirred until the paste dissolved.

### Example 4

Recipe with Whole Flax without Mucilage

Mucilage was removed from whole flax seeds by adding water at ratio 1/7 (w/v), adjusting the pH to 6 (using NaOH or HCl 1M), and stirring at 70 °C for 1 hour using a Heidolph overhead mixer. A simple separation was necessary to remove the mucilage from whole flax seeds using a kitchen strainer.

The soup concentrate recipe was prepared as follows: the first step was the mixing of wet components (sunflower oil, soy protein, onion powder, and other flavor components) as a pre-blend wet base component which was then mixed and sheared with crystals and milk powder at speed 8 for 30 seconds using a Thermomix then speed 3, for 3 minutes to prevent lumps. The flax without mucilage was added during this process to around 9.62% of the wet components total weight. Separately, the dry components comprising mainly of spices were mixed in a bowl to prevent lumps. Both wet and dry mixes were then combined and preblended at speed 3 for 3 minutes using a Thermomix and then pasteurized for 5 minutes at 85 °C, speed 3 with Thermomix. The mixture was then cooled down to 40 °C either by using a Blast Chiller, or at room temperature, whereby the paste was put in an aluminum bowl and then using ice for 5 minutes maximum. Starch and water were added to the slurry using a Thermomix, at speed 4 for 1 minute and then poured into a pouch and stored at room temperature. To make the soup, the paste was dilute 1:4 with hot water and stirred until the paste dissolved.

### Example 5

Recipe with Flax Oil

The soup concentrate recipe was prepared as follows: the first step was the mixing of wet components (sunflower oil, soy protein, onion powder, and other flavor components) as a pre-blend wet base component which was then mixed and sheared with crystals and milk powder at speed 8 for 30 sec using Thermomix then speed 3, for 3 minutes to prevent lumps. The flax oil was added during this process to around 2% of the wet components total weight. Separately, the dry components comprising mainly of spices were mixed in a bowl to prevent lumps. Both wet and dry mixes were then combined and preblended at speed 3 for 3 minutes using Thermomix and then pasteurized for 5 min at 85 °C, speed 3 with Thermomix. The mixture was then cooled down to 40 °C either by using a Blast Chiller, or at room temperature, whereby the paste was put in an aluminum bowl and then using ice for 5 minutes maximum. Starch and water were added to the slurry using a Thermomix, at speed 4 for 1 minute and then poured into a pouch and stored at room temperature. To make the soup, the paste was dilute 1:4 with hot water and stirred until the paste dissolved.

Stability at room temperature was measured over a 6 month period and recorded in Table 3.

TABLE 3

| | T0 | T (6 months) |
|---|---|---|
| Smell | No fishy | Rancid and |
| (sniffing) | smell | fishy smell |

1. A method of making a savory product, the method comprising:
a) wet mixing a composition comprising (i) one or more of flax seed, hemp or chia; (ii) an oil source; and (iii) a protein source;
b) blending the wet mix;
c) heating the blended mix; and
d) cooling the heated mix to form a savory product with a total solid content between 10 to 65 wt %.

2. The method according to claim 1, wherein the oil source and the protein source are not derived from any of flax seed, hemp, or chia.

3. The method according to claim 1, wherein the one or more of flax seed, hemp or chia comprise flax seeds, and mucilage has been substantially removed from the flax seeds.

4. The method according to claim 3, wherein the mucilage has been substantially removed by mixing the flax seeds in water to form a mixture, adjusting the pH of the mixture to about 6, and applying heat to the mixture.

5. The method according to claim 1, wherein the flax seeds are at least 50% dehulled.

6. The method according to claim 1, wherein the flax seeds are whole flax seeds.

7. The method according to claim 1, wherein the wet mix is formed by shearing the one or more of flax seeds, hemp, or chia in water with crystals and with the protein source, wherein the protein source is a protein powder, and wherein the crystals are salt and/or sugars.

8. The method according to claim 1, wherein the wet mix in step (i) is pre-blended, before blending with a dry mix of ingredients.

9. The method according to claim 1, wherein the blended mix is heated to at least 85 °C in step (c).

10. The method according to claim 1, wherein the blended mix is cooled down to about 40 °C in step d) after the heating.

11. The method according to claim 1, wherein starch and optionally water is added during or after the cooling in step d).

12. A savory product comprising between 5 to 20 wt % flax seeds.

13. The savory product according to claim 12, wherein the flax seeds are at least 50% dehulled and/or substantially free of mucilage.

14. A liquid soup product made by mixing a soup concentrate in water, the soup concentrate comprising between 5 to 20 wt % flax seeds.

15. The savory product according to claim 12, wherein the savory product is substantially devoid of emulsifiers and/or antioxidants.

16. A method of making a savory product, the method comprising adding flax seed which is at least 50% dehulled and/or substantially free of mucilage to at least one other ingredient.

17. The savory product according to claim 12, wherein the savory product is a soup concentrate.

18. The method according to claim 1, wherein the savory product is a soup concentrate.
